(19) United States
(12) Patent Application Publication
(10) Pub. No.: US 2007/0081434 A1
(43) Pub. Date: Apr. 12, 2007

(54) APPARATUSES AND RELATED METHODS OF WRITING QUALITY CONTROL FOR OPTICAL RECORDING

(76) Inventors: Fu-Shan Wang, Tai-Nan City (TW); Pie-Lun Yu, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/163,224

(22) Filed: Oct. 11, 2005

(51) Int. Cl. G11B 19/00; G11B 7/00; G11B 20/00

(52) U.S. Cl. 369/47.41; 369/53.31; 369/53.38

(57) ABSTRACT

Apparatuses and methods for controlling the quality of writing an optical storage medium in an optical storage system having an accessing logic for steering data to be written onto or read from the optical storage medium. The apparatus contains a halting controller, an evaluation device, a recording tangential velocity (RTV) adjusting device, and a starting controller. The halting controller requests the accessing logic to halt a write procedure at a stopping point. The evaluation device evaluates the writing quality of a portion of the data recorded onto the optical storage medium to generate an evaluation result. The RTV adjusting device requests the accessing logic to adjust the RTV of the optical storage medium if the evaluation result does not satisfy predetermined criteria. Finally, the starting controller requests the accessing logic to restart the write procedure to continue writing data onto the optical storage medium.

### BACKGROUND

The invention relates to writing quality control for an optical storage medium, and more particularly, to apparatuses and related methods for controlling the writing quality of the optical storage medium during optical recording.

When writing data onto an optical storage medium (e.g. optical disc), an optimum power calibration (OPC) is performed on a specific area called power calibration area (PCA) of the optical storage medium to acquire a preferred write power utilized for data recording. The specific area is usually located at an inner most track of the optical storage medium and the write power determined by the OPC process performed on the inner most track may not be applicable to data recording onto an outer track. Since write power is crucial to the writing quality of an optical storage medium, an unsuitable write power may render written data on the optical storage medium unable to be read back correctly. To solve this problem, in addition to calibrate the write power at an inner track, a conventional method performs the OPC process on an outer track, too. A write power for any track located between the inner track and the outer track may be determined by interpolation. However, a characteristic of the optical storage medium between the inner and outer tracks of the optical storage medium may not change linearly, causing this conventional interpolation method fail to accurately predict a preferred write power. The write power determined by the OPC process is insufficient for data recording everywhere on the optical disc due to numerous of factors such as tilt drift, temperature variation, and unevenness of the dye.

Some other conventional methods utilize dynamically compensation process such as a running optimum power control (ROPC) procedure to dynamically adjust write power to overcome the above-mentioned problem. A ROPC method monitors a characteristic of a writing radio frequency (WRF) signal used to write data onto an optical storage medium, and dynamically compensates laser power by comparing the current monitored value with a target characteristic value. Nevertheless, a signal-to-noise ratio (SNR) is usually poor as this method utilizes the WRF signal as a reference for power calibration.

In U.S. Pat. No. 6,636,468, another dynamic write power control method is provided. In this method, some stopping points are set during a write procedure, and at each stopping point, data previously written during the write procedure is read. According to the read-back data, a write power is adjusted and the write procedure is restarted using the adjusted write power. However, adjusting a write power to control writing quality of an optical storage medium causes a radio frequency (RF) amplitude level to vary during a write procedure, and the amount of the write power capable of being controlled is limited due to a physical limit of a laser diode used to record data onto the optical storage medium. All of these factors degrade the writing quality.

### SUMMARY

Apparatuses and related methods of controlling a writing quality for optical recording by adapting the recording tangential velocity are provided.

Some embodiments of an apparatus for controlling writing quality of an optical storage system are provided. The optical storage system has an accessing logic for steering data to be written onto or read from an optical storage medium. The apparatus comprises a halting controller, an evaluation device, a recording tangential velocity (RTV) adjusting device, and a starting controller. The halting controller, coupled to the accessing logic, requests the accessing logic to halt a write procedure at a stopping point. The evaluation device, coupled to the accessing logic, requests the accessing logic to read at least a portion of data recorded onto the optical storage medium and evaluates the writing quality while reading the portion of the data to generate an evaluation result. The RTV adjusting device, coupled to the evaluation device and the accessing logic, requests the accessing logic to adjust the RTV of the optical storage medium if the evaluation result does not satisfy predetermined criteria. Finally, the starting controller, coupled to the accessing logic, requests the accessing logic to restart the write procedure to continue writing data onto the optical storage medium.

In addition, some embodiments of a writing quality controlling method comprises halting a write procedure at a stopping point, reading at least a portion of a data recorded onto the optical storage medium in the write procedure, evaluating the writing quality of the portion of the data to generate an evaluation result, adjusting the recording tangential velocity (RTV) of the optical storage medium if the evaluation result does not satisfy predetermined criteria, and restarting the write procedure to continue writing data onto the optical storage medium.

Embodiments of an apparatus for controlling the writing quality of an optical storage system are also provided. The optical storage system contains an accessing logic for steering data to be written onto or read from an optical storage medium. Some embodiments of the apparatus comprise an evaluation device, and a recording tangential velocity (RTV) adjusting device. The evaluation device, coupled to the accessing logic, evaluating the writing quality by detecting at least a characteristic parameter during a write procedure to generate an evaluation result. The RTV adjusting device, coupled to the evaluation device and the accessing logic, requests the accessing logic to adjust the RTV of the optical storage medium if the characteristic parameter does not satisfy predetermined criteria.

Furthermore, some embodiments of a method for controlling the writing quality of an optical storage system comprise evaluating the writing quality by detecting at least a characteristic parameter during a write procedure to generate an evaluation result, and adjusting the RTV of the optical storage medium if the characteristic parameter does not satisfy predetermined criteria.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an optical storage system according to a first embodiment of the present invention.

FIG. 2 is a flow chart illustrating a writing quality control method performed by the optical storage system shown in FIG. 1.

FIG. 3 is a block diagram illustrating an optical storage system according to a second embodiment of the present invention.

FIG. 4 is a flow chart illustrating a writing quality control method performed by the optical storage system shown in FIG. 3.

FIG. 5 is a diagram illustrating the adaptive behavior of the RTV and a spindle rotation speed after activating the provided method under a constant linear velocity mode.

FIG. 6 is a diagram illustrating the adaptive behavior of the RTV and a spindle rotation speed after activating the provided method under a constant angular velocity mode.

### DETAILED DESCRIPTION

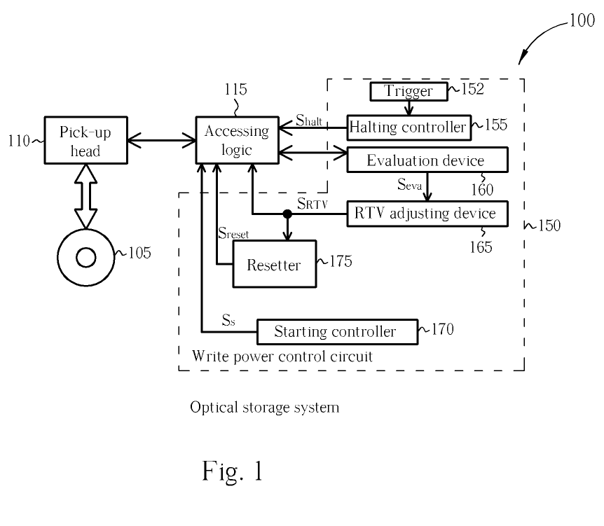

FIG. 1 is a block diagram illustrating an optical storage system 100 according to a first embodiment of the writing quality control apparatus. As shown in FIG. 1, the optical storage system 100 comprises a pick-up head 110, an accessing logic 115, and a write power control circuit 150. In this embodiment, the write power control circuit 150 comprises a trigger 152, a halting controller 155, an evaluation device 160, a recording tangential velocity (RTV) adjusting device 165, a starting controller 170, and a resetter 175. The accessing logic 115 steers data to be written onto or read from an optical disc 105 by the pick-up head 110. In a write procedure for writing data onto the optical disc 105, a write strategy and a write power for recording the data are determined by an optimum power control (OPC) calibration. In addition, the RTV is determined or set according to a recording speed that is determined by a host or directly set by a user. The accessing logic 115 records data onto the optical disc 105 according to the RTV, the adopted write strategy, and the calibrated write power by driving the pick-up head 110. During the write procedure, the halting controller 155 will be activated to halt the write procedure at a stopping point. The stopping point is generated by the trigger 152. The stopping point can be determined by a variety of ways. For instance, in one embodiment, the trigger 152 is a timer. When the timer expires, a halting signal Shalt is sent to the accessing logic 115 to halt the write procedure. In addition, the trigger 152 may be triggered by any of a timer, temperature sensor, velocity detector, recording location determiner, recording mode controller, and a running optimum power calibration (ROPC). The recording mode controller generates the stopping point when a recording mode is changed, and the ROPC logic monitors a laser reflection during the write procedure and generates a stopping point when a laser characteristic deviation exceeds a predetermined amount. Alternatively, in another embodiment the halting controller 155 monitors some parameters (for example, temperature) by itself and when a sufficient change of a specific parameter is detected, the halting signal Sₕₐₗₜ is sent to the accessing logic 115. In a packet-type writing procedure, the stopping point is an end of a packet. After the write procedure is halted, the evaluation device 160 requests the accessing logic 115 for at least a portion of the data recorded onto the optical disc 105 in a previous session of the write procedure. The evaluation device 160 then performs an evaluation operation on the retrieved data to generate an evaluation signal Sₑᵥₐ. The evaluation operation detects at least a physical characteristic of the retrieved data, such as bit error rate, RF amplitude, RF symmetry, tangential push pull (TPP) amplitude, differential phase detection (DPD) amplitude, or jitter, to generate the evaluation signal Sₑᵥₐ. Therefore, values transmitted by the evaluation signal Sₑᵥₐ represent a writing quality of the recorded data in a previous session of the write procedure, i.e., before the stopping point.

The evaluation signal Sₑᵥₐ is fed into the RTV adjusting device 165. Then the RTV adjusting device 165 checks whether an evaluation result represented by the values transmitted via the evaluation signal Sₑᵥₐ satisfies any of the predetermined criteria. If it is satisfied, the RTV adjusting device 165 will not adjust the RTV of the optical disc 105, and the accessing logic 115 restarts the currently halted write procedure when receiving a starting signal S_{S} outputted from the starting controller 170. On the other hand, if the evaluation result fails to satisfy the predetermined criteria, the RTV adjusting device 165 will generate an RTV adjusting signal S_{RTV} and deliver it to the accessing logic 115. In this embodiment, the well-known servo control mechanism is implemented in the accessing logic 115. Therefore, as the accessing logic 115 receives the RTV adjusting signal S_{RTV}, the servo control mechanism controls the rotation speed of the optical disc 105, resulting in an adjustment to the RTV. In some embodiments, values transmitted by the RTV adjusting signal S_{RTV} are determined via utilizing a look-up table. However, the utilization of the look-up table is only an example for implementing the RTV adjusting device 165 and is not meant to be taken as a limitation of the present invention. For example, in other embodiments, the RTV adjusting device 165 can also determine the RTV adjusting signal S_{RTV} by utilizing linear/non-linear transform, fuzzy logic, or other artificial intelligence algorithms. Please note that the RTV of the accessing logic 115 is utilized to compensate one or a combination of defects in the coating of the optical storage medium 105, variation in ambient temperature, variation in track radius, variation in laser power level, tilt, and defocus.

As shown in FIG. 1, the RTV adjusting signal S_{RTV} is further fed into the resetter 175. The resetter 175 examines if a percentage of an adjusting amount of the RTV reaches a threshold value (e.g., 20%). If the percentage of the adjusting amount of the RTV does not reach the threshold value, the resetter 175 ignores the incoming RTV adjusting signal S_{RTV} and the accessing logic 115 adjusts the RTV according to the received RTV adjusting signal S_{RTV}. The starting controller 175 sends the starting signal S_{S} to the accessing logic 115 and then the write procedure is restarted. However, if the percentage of the adjusting amount of the RTV reaches the threshold value, the resetter 175 generates a reset signal Sᵣₑₛₑₜ to request the accessing logic 115 to update the write strategy in conjunction with the write power. That is, when the currently used RTV requires a significant amount of adjustment to compensate the detected variation, it means many other parameters may also need to be adjusted in addition to the write power. In one embodiment of the accessing logic 115, when receiving the reset signal Sᵣₑₛₑₜ, the accessing logic 115 performs the OPC calibration again to update the write strategy and the write power. After the write strategy and the write power are updated, the accessing logic 115 restarts the write procedure when receiving the starting signal S_{S} from the starting controller 170. Please note that the implementation and the operation of the starting controller 170 are not specified here, any device capable of achieving the same functionality as the starting controller 170 is applicable to the present invention.

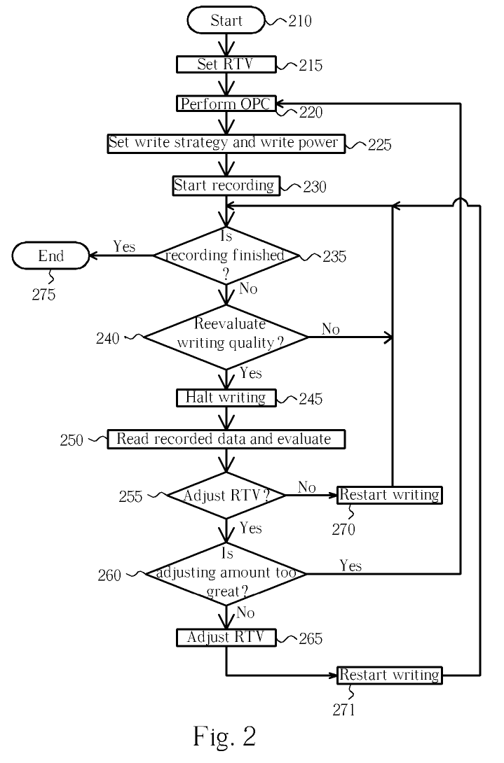

FIG. 2 is a flow chart illustrating a writing quality control method performed by the optical storage system 100 shown in FIG. 1. FIG. 2 summarizes the writing quality control method of the optical storage system 100 and each step is described as follows:

Step 210: The optical storage system 100 starts a write procedure.

Step 215: An RTV for the write procedure is set according to a predetermined recording speed.

Step 220: Perform an OPC calibration.

Step 225: A write strategy and a write power of the write procedure is determined according to results from the OPC calibration

Step 230: Start to record data onto the optical disc 105 according to the RTV, the write strategy and the write power.

Step 235: Check if the data to be recorded is entirely recorded onto the optical disc 105. If yes, go to Step 275; otherwise, go to Step 240.

Step 240: Has the trigger 152 indicated the writing quality should be reevaluated? If yes, go to Step 245; otherwise, go to Step 235.

Step 245: Halt the write procedure at the stopping point.

Step 250: Read at least a part of the recorded data from the optical disc 105 and perform an evaluation operation.

Step 255: Does a result of the evaluation operation indicate that the RTV requires adjustment? If yes, go to Step 260; otherwise, go to Step 270.

Step 260: Is an adjusting amount of the RTV greater than a threshold? If yes, go to Step 220; otherwise, go to Step 265.

Step 265: Adjust the RTV according to the evaluation result.

Step 270: Restart the write procedure utilizing the original write strategy, the original write power and the original RTV, and then go back to Step 235.

Step 271: Restart the write procedure utilizing the original write strategy, the original write power and the updated RTV, and then go back to Step 235.

Step 275: End the write procedure.

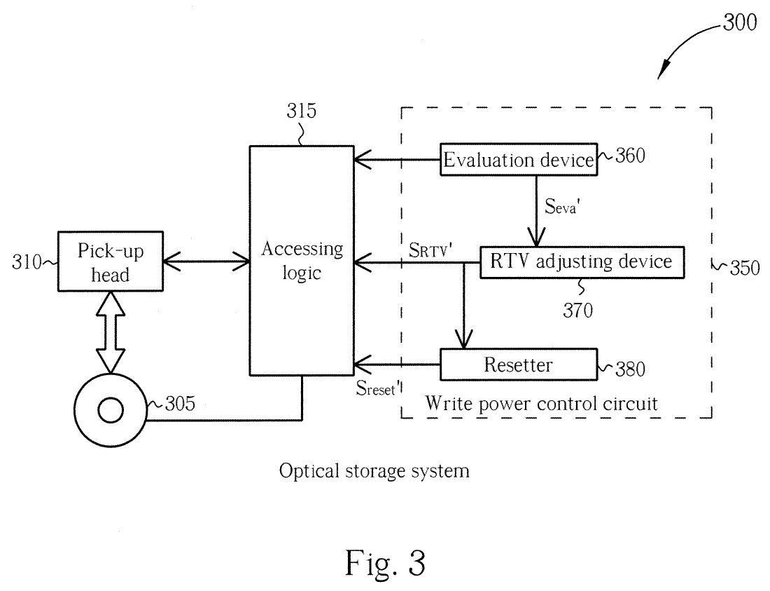

FIG. 3 is a block diagram illustrating an optical storage system 300 according to a second embodiment of the writing quality control apparatus. As shown in FIG. 3, the optical storage system 300 comprises a pick-up head 310, an accessing logic 315, and a write power control circuit 350. In this embodiment, the write power control circuit 350 comprises an evaluation device 360, a recording tangential velocity (RTV) adjusting device 370, and a resetter 380. The accessing logic 315 steers data to be written onto or read from an optical disc 305 by the pick-up head 310. In a write procedure for writing data onto the optical disc 305, a write strategy and a write power for recording the data are firstly determined by an optimum power control (OPC) calibration. In addition, the RTV is determined or set according to a recording speed that is determined by a host or directly set by a user. The accessing logic 315 records data onto the optical disc 305 according to the RTV, the determined write strategy and the calibrated write power by driving the pick-up head 310. During the write procedure, the evaluation device 360 monitors a writing radio frequency (WRF) signal and determines at least a characteristic parameter to represent a writing quality of the currently running write procedure. In this embodiment, the write procedure does not require halting when the evaluation device 360 is monitoring the WRF signal. When a change in any of the monitored parameters is detected, the evaluation device 360 generates an evaluation result according to the characteristic parameter. The evaluation result is then provided to the RTV adjusting device 370 by an evaluation signal Sₑᵥₐ′. The RTV adjusting device 370 checks whether the evaluation result transmitted by the evaluation signal Sₑᵥₐ′ satisfies predetermined criteria. If yes, the RTV adjusting device 370 will not adjust the RTV of the optical disc 305. On the other hand, if the evaluation result fails to satisfy the predetermined criteria, the RTV adjusting device 370 will generate an RTV adjusting signal S_{RTV}′ to the accessing logic 315. The accessing logic 315 then adjusts the RTV of the optical disc 305 according to the RTV adjusting signal S_{RTV}′. In this embodiment, a servo control mechanism is implemented in the accessing logic 315. As the accessing logic 315 receives the RTV adjusting signal S_{RTV}′, the servo control mechanism controls the rotation speed of the optical disc 305, resulting in an adjustment to the RTV. Furthermore, in one embodiment of the RTV adjusting device 370, values transmitted by the RTV adjusting signal S_{RTV}′ are determined utilizing a look-up table. However, the utilization of the look-up table is only an example for implementing the RTV adjusting device 370 and is not meant to be taken as a limitation of the present invention. The RTV of the accessing logic 315 in the present invention is utilized to compensate one or a combination of defects in coating of the optical storage medium 305, variation in ambient temperature, variation in track radius, variation in laser power level, tilt, and defocus.

The RTV adjusting signal S_{RTV}′ is further fed into the resetter 380. The resetter 380 examines if an adjusting amount of the RTV reaches a threshold value (e.g., 20%). If the adjusting amount of the RTV does not reach the threshold value, the resetter 380 ignores the RTV adjusting signal S_{RTV}′ and the accessing logic 315 adjusts the RTV according to the RTV adjusting signal S_{RTV}′. However, if the adjusting amount of the RTV reaches or exceeds the threshold value, the resetter 380 generates a reset signal Sᵣₑₛₑₜ′ to request the accessing logic 315 to update the write strategy and the write power. That is, when the RTV currently in use requires a significant amount of adjustment, it means many other parameters may also need to be adjusted in addition to the write power. In one embodiment of the accessing logic 315, when receiving the reset signal Sᵣₑₛₑₜ′, the accessing logic 315 halts the write procedure temporarily and then performs the OPC calibration again to update the write strategy and the write power. After the write strategy and the write power are updated, the write procedure is restarted.

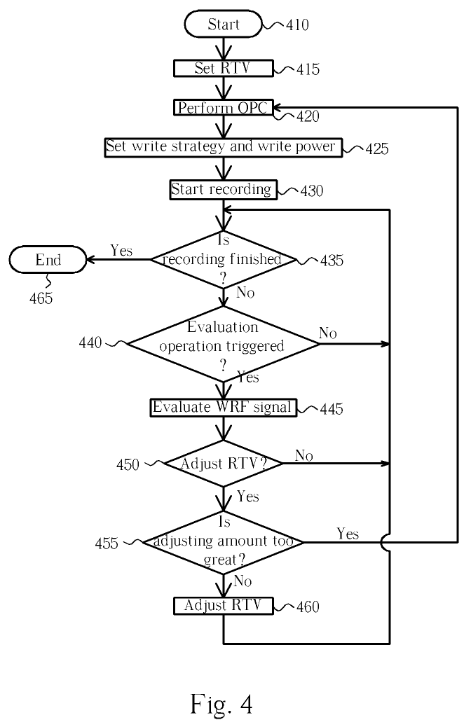

FIG. 4 is a flow chart illustrating a writing quality control method performed by the optical storage system 300 shown in FIG. 3. FIG. 4 summaries the writing quality control method of the optical storage system 300 and each step is described as follows:

Step 410: The optical storage system 300 starts a write procedure.

Step 415: An RTV for the write procedure is set according to a predetermined write speed.

Step 420: Perform an OPC calibration.

Step 425: A write strategy and a write power of the write procedure is determined according to results from the OPC calibration

Step 430: Start to record data onto the optical disc 305 utilizing the RTV, the write power, and the write strategy.

Step 435: Check if the data to be recorded is entirely recorded onto the optical disc 305. If yes, go to Step 465; otherwise, go to Step 440.

Step 440: Is an evaluation operation being triggered? If yes, go to Step 445; otherwise, go to Step 430.

Step 445: Perform the ROPC operation by evaluating the WRF signal during data recording, and generate at least a characteristic parameter transmitted by an evaluation signal Sₑᵥₐ′ representing writing quality of the currently running write procedure.

Step 450: Check if RTV adjustment is required by examining the characteristic parameter. If the RTV adjustment is required, go to Step 455; otherwise, go to Step 430.

Step 455: Is an adjusting amount of the RTV greater than a threshold? If yes, go to Step 420; otherwise, go to Step 460.

Step 460: Adjust the RTV utilized by the currently in use write procedure according to the characteristic parameter, and then go back to Step 435.

Step 465: End the write procedure.

The present invention provides a mechanism for controlling writing quality when writing data onto an optical storage medium of an optical storage system. Specifically, an RTV adopted by the optical storage system, instead of a write power of the optical storage system, is adapted in order to compensate various changes and thus improve the writing quality. By adapting the RTV, some physical properties of writing the optical storage medium, such as maintaining a constant RF level, is better than the conventional means of changing the write power. Additionally, there is a physical limit imposed on the laser diode which restricts the maximum write power be used for data recording. However, it is not a concern to the writing quality control mechanism that improves the writing quality by changing the RTV of the optical storage medium.

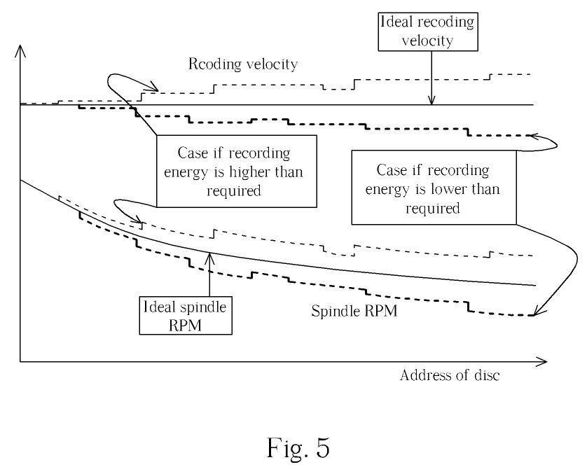

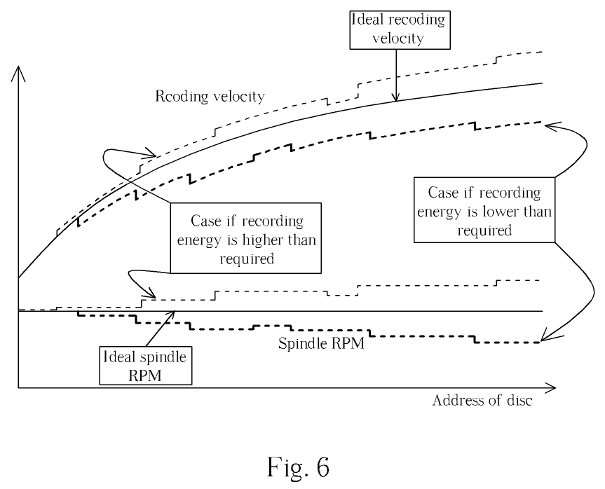

FIG. 5 is a diagram illustrating the adaptive behavior of the RTV and a spindle rotation speed after activating the provided method under a constant linear velocity (CLV) mode and FIG. 6 is a diagram illustrating the adaptive behavior of the RTV and a spindle rotation speed after activating the provided method under a constant angular velocity (CAV) mode. As shown in the two figures, when the recording power is lower than the required power, the RTV will be reduced to maintain the writing quality. On the other hand, if the recording power is higher than required power, the RTV will be increased to maintain the writing quality. The writing quality control apparatuses and methods are applicable to CLV and CAV or other hybrid mode, such as ZCLV (zone CLV), PCAV (partial CAV), for data recording.

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus of controlling a writing quality for data recording on an optical storage medium of an optical storage system, the optical storage system having an accessing logic for steering data to be written onto or read from the optical storage medium, the apparatus comprising:
a halting controller, coupled to the accessing logic, requesting the accessing logic to halt a write procedure at a stopping point;
an evaluation device, coupled to the accessing logic, requesting the accessing logic to read at least a portion of the data recorded onto the optical storage medium and evaluating the writing quality while reading the portion of the data to generate an evaluation result;
a recording tangential velocity (RTV) adjusting device, coupled to the evaluation device and the accessing logic, requesting the accessing logic to adjust the RTV of the optical storage medium if the evaluation result not satisfying predetermined criteria; and
a starting controller, coupled to the accessing logic, requesting the accessing logic to restart the write procedure to continue writing data onto the optical storage medium.

2. The apparatus of claim 1, further comprising:
a resetter, coupled to the accessing logic and the RTV adjusting device, requesting the accessing logic to update a write strategy and write power of the write procedure if an adjusting amount of the RTV reaches a threshold value.

3. The apparatus of claim 2, wherein the write strategy and write power are determined by performing an optimum power control (OPC) calibration.

4. The apparatus of claim 1, wherein the evaluation device detects at least one parameter representing a physical characteristic of the data to generate the evaluation result.

5. The apparatus of claim 4, wherein the evaluation device detects one or more of the following parameters as the physical characteristic of the data: error rate, RF amplitude, RF symmetry, TPP amplitude, DPD amplitude, or jitter.

6. The apparatus of claim 1, wherein the RTV adjusting device determines the RTV of the optical storage medium or an adjusting amount of the RTV by searching a look-up table with the evaluation result, or by utilizing linear/non-linear transform, fuzzy logic, or other artificial intelligence algorithms.

7. The apparatus of claim 1, wherein the RTV of the accessing logic is adjusted to compensate one or a combination of variation in coating of the optical storage medium, variation in ambient temperature, variation in track radius, variation in laser power level, tilt, and defocus.

8. The apparatus of claim 1, further comprising a trigger for generating the stopping point for the halting controller to request the accessing logic to halt the write procedure.

9. The apparatus of claim 8, wherein the trigger comprises one or a combination of a timer, temperature sensor, velocity detector, recording location determiner, recording mode controller which generates the stopping point when a recording mode is changed, and running optimum power control (ROPC) logic which monitors a laser reflection during the write procedure and generates a stopping point when a laser characteristic deviation exceeds a predetermined amount.

10. The apparatus of claim 1, wherein the stopping point is an end of a packet for a packet-type writing.

11. The apparatus of claim 1, wherein the accessing logic restarts the write procedure at a starting point prior to the stopping point.

12. A method of controlling a writing quality for data recording on an optical storage medium of an optical storage system, comprising:
halting a write procedure at a stopping point;
reading at least a portion of the data recorded on the optical storage medium in the write procedure;
evaluating the writing quality of the portion of the data to generate an evaluation result;
adjusting the recording tangential velocity (RTV) of the optical storage medium if the evaluation result not satisfying predetermined criteria; and
restarting the write procedure to continue writing data onto the optical storage medium.

13. The method of claim 12, further comprising:
updating a write strategy and write power of the write procedure if an adjusting amount of the RTV reaches a threshold value.

14. The method of claim 13, wherein the write strategy and write power are determined by performing an optimum power control (OPC) calibration.

15. The method of claim 12, wherein evaluating the writing quality of the portion of the data comprises detecting at least one parameter representing the physical characteristic of the data to generate the evaluation result.

16. The method of claim 15, wherein the parameters representing the physical characteristic of the data comprise error rate, RF amplitude, RF symmetry, TPP amplitude, DPD amplitude, or jitter.

17. The method of claim 12, wherein adjusting the RTV further comprises determining the RTV of the optical storage medium or an adjusting amount of the RTV by searching a look-up table with the evaluation result, or by utilizing linear/non-linear transform, fuzzy logic, or other artificial intelligence algorithms.

18. The method of claim 12, wherein the RTV is adjusted to compensate one or a combination of variation in coating of the optical storage medium, variation in ambient temperature, variation in track radius, variation in laser power level, tilt, and defocus.

19. The method of claim 12, further providing a trigger for generating the stopping point utilized to halt the write procedure.

20. The method of claim 19, wherein the trigger is triggered by one or a combination of a timer, temperature sensor, velocity detector, recording location determiner, recording mode controller which generates the stopping point when a recording mode is changed, and running optimum power control (ROPC) logic which monitors a laser reflection during the write procedure and generates a stopping point when a laser characteristic deviation exceeds a predetermined amount.

21. The method of claim 12, wherein the stopping point is an end of a packet for packet-type writing.

22. The method of claim 12, wherein the write procedure is restarted at a starting point prior to the stopping point.

23. An apparatus of controlling a writing quality for data recording on an optical storage medium of an optical storage system, the optical storage system having an accessing logic for steering data to be written onto or read from the optical storage medium, the apparatus comprising:
an evaluation device, coupled to the accessing logic, evaluating the writing quality by detecting at least a characteristic parameter during a write procedure to generate an evaluation result; and
a recording tangential velocity (RTV) adjusting device, coupled to the evaluation device and the accessing logic, for requesting the accessing logic to adjust the RTV of the optical storage medium if the characteristic parameter not satisfying predetermined criteria.

24. The apparatus of claim 23, further comprising:
a resetter, coupled to the accessing logic and the RTV adjusting device, for requesting the accessing logic to update a write strategy and write power of the write procedure if an adjusting amount of the RTV reaches a threshold value.

25. The apparatus of claim 24, wherein the write strategy and write power are determined by performing an OPC calibration.

26. The apparatus of claim 23, wherein the RTV adjusting device requests the accessing logic to adjust the RTV of the optical storage medium during the write procedure.

27. The apparatus of claim 23, wherein the RTV adjusting device determines the RTV of the optical storage medium by searching a look-up table with the evaluation result, or by utilizing linear/non-linear transform, fuzzy logic, or other artificial intelligence algorithms.

28. The apparatus of claim 23, wherein the RTV of the accessing logic is adjusted to compensate one or a combination of variation in coating of the optical storage medium, variation in ambient temperature, variation in track radius, variation in laser power level, tilt, and defocus.

29. A method for controlling a writing quality for data recording on an optical storage medium of an optical storage system, comprising:
evaluating the writing quality by detecting at least a characteristic parameter during a write procedure to generate an evaluation result; and
adjusting the RTV of the optical storage medium if the characteristic parameter not satisfying predetermined criteria.

30. The method of claim 29, further comprising:
updating a write strategy and a write power of the write procedure if an adjusting amount of the RTV reaches a threshold value.

31. The method of claim 30, wherein the write strategy and the write power are determined by performing an optimum power control (OPC) calibration.

32. The method of claim 29, wherein the step of adjusting the RTV of the optimum medium is performed during the write procedure.

33. The method of claim 29, wherein the step of adjusting the RTV determines the RTV of the optical storage medium by searching a look-up table with the evaluation result, or by utilizing linear/non-linear transform, fuzzy logic, or other artificial intelligence algorithms.

34. The method of claim 29, wherein the RTV is adjusted to compensate one or a combination of variation in coating of the optical storage medium, variation in ambient temperature, variation in track radius, variation in laser power level, tilt, and defocus.
